(19) United States
(12) Patent Application Publication
(10) Pub. No.: US 2003/0013376 A1
(43) Pub. Date: Jan. 16, 2003

(54) Psychological support plaything and method

(75) Inventors: Eric Larson, Bloomfield Hills, MI (US); Katherine Larson, Bloomfield Hills, MI (US); Robert Lawrence, Bloomfield Hills, MI (US); Julie A. Fream, Blooomfield Hills, MI (US); Douglas Graham, Bloomfield Hills, MI (US); Janet Graham, Birmingham, MI (US); Michael Simmons, Bloomfield Hills, MI (US); Stacey Simmons, Bloomfield Hills, MI (US); Charles P. Hines JR., Hamburg, MI (US)

Correspondence Address: Eric M. Dobrusin, Dobrusin & Thennisch PC, Suite 311, 401 South Old Woodward Avenue, Birmingham, MI, 48009, US

(73) Assignee: MS Partners, LLC

(21) Appl. No.: 10/151,409

(22) Filed: May 20, 2002

Related U.S. Application Data
(60) Provisional application No. 60/292,489, filed on May 21, 2001.

(51) Int. Cl. G09B 19/00

(52) U.S. Cl. 446/236; 434/236

(57) ABSTRACT

A method for assisting a child to overcome a fear with a plaything, comprising the steps of providing a dispensing component, fixing in a tangible medium a story written for helping a child to confront and overcome a fear, providing access to the story in combination with the dispensing component, and directing an end user to read the story and to dispense using the dispensing component at select intervals during such reading.

### CLAIM OF BENEFIT OF FILING DATE

The present application claims the benefit of the filing date of U.S. Provisional Application Serial No. 60/292,489 (filed May 21, 2001), the contents of which are hereby expressly incorporated by reference herein.

### TECHNICAL FIELD

The present invention relates to a psychological support plaything, and more particularly to a method and system for helping children to improve self confidence and overcome fears.

### BACKGROUND

The recognition and treatment of childhood fears has been the subject of considerable investigation. Childhood fears (e.g., fear of the dark, fear of monsters, fear of animals, fear of insects, fear of snakes or the like) are numerous and are typically the result of powerful imaginings of children. A number of devices, games, techniques and other methods and playthings exist for engaging the imagination of juveniles and fostering psychological development.

One way for treating the fear is through desensitization. In that approach, a child is gradually subjected to the fear-evoking situation. Through systematic recurrence without incident and, often with positive reinforcement, the child learns to manage the fear. Modeling is another approach used to help a child overcome a fear. In this approach, the child is placed in an environment where the child can observe that other people are not afraid of the situation that the child fears. It is contemplated that in making such observations, the child will confront the fear-evoking situation. Yet another approach is to discuss the fear-evoking situation and to role play with the child, gently coaxing and preparing the child to confront the fear-evoking situation.

In each of the above approaches, and in other approaches, an object of the treatment is to develop the ability of the child to trust in a situation and to distinguish between real and imaginary dangers. In order to do so, it is believed to be advantageous to engage a child with an instrument, such as a game, toy, storybook, or the like. See, e.g., U.S. Pat. No. 3,940,863 (Kritzberg), hereby incorporated by reference.

U.S. Pat. No. 5,564,961 (Spector) discloses a water-pistol and puppet assembly. U.S. Pat. No. 5,846,116 (DiResta, et al.) discloses a squeezable hand toy that makes noises. Both of these patents are hereby expressly incorporated by reference.

There is currently marketed a product named “BOO BUSTER”, in which it appears that a mixture of purified water, bubble gum fragrance concentrate and preservative is provided in a pump spray bottle. According the promotional materials, users are directed to “Spray under beds, in closets, behind doors and in other scary areas” of a child's room. (See, www.inventiveparent.com/boobuster.htm). It would be desirable to be able to improve upon this concept with an additional therapeutic object for enhancing the active direct engagement of the child in overcoming the fear.

### SUMMARY OF THE INVENTION

The present invention meets the above needs by providing an improved method for assisting a child to overcome a fear, using a plaything, comprising the steps of providing a fluid dispensing component, fixing in a tangible medium a story written for helping a child to confront and overcome a fear, providing access to the story in combination with the fluid dispensing component, and directing an end user to read the story and to dispense fluid using the fluid dispensing component at select intervals during such reading.

In a particularly preferred aspect, the present invention is directed to a method for assisting a child to overcome a fear, using a plaything, comprising the steps of providing a fluid dispensing assembly including a nozzle (which is optionally adjustable for controlling output flow, e.g., for a continuous stream, a mist, or otherwise, and a molded container made of a thermoplastic material, e.g., a plastic selected from the group consisting of polyethylene terephthalate, or polyethylene; causing the molded container to be filled with a generally inert and non-toxic, water-based fluid; providing a book including a theme about a child that confronts a fear by spraying a fluid at an imagined situation; causing the book to be packaged in combination with the fluid dispensing assembly; directing an end user to read the book and to dispense fluid from the blow-molded container at select intervals during such reading that are identified by in the book.

In yet another aspect, the present invention contemplates a method for assisting a child to overcome a fear of monsters, using a plaything, comprising the steps of providing a fluid dispensing assembly including a nozzle, and a blow-molded container made of a plastic selected from the group consisting of polyethylene terephthalate, or polyethylene, at least one of the nozzle or the container being molded in the configuration of a fanciful creature; causing the blow-molded container to be filled with a generally inert and non-toxic, water-based fluid; providing a book including a theme about a child that confronts a fear of monsters by spraying a fluid at an imagined monster, the book and the container being adapted for temporary mechanical attachment to each other; causing the book to be packaged in combination with the fluid dispensing assembly; and directing an end user to read the book and to dispense fluid from the blow-molded container at select intervals during such reading that are identified by in the book.

The above aspects of the invention also contemplate an additional step of providing an audio rendering of the story of the book, a video rendering of the story of the book or a combination thereof. Yet another aspect of the invention contemplates providing a battery operated device (such as a light or a sound producer) that is adapted for attachment to the nozzle, the container or both.

Aspects of the invention also lie in the assembled kit that is achieved by following the above steps, as well as in the use of the contents of the kit by children alone or more preferably under supervision of an older person (e.g., under adult supervision). For example, the contents of the kit may be used by a parent with an offspring, between siblings, in a group of a plurality of children, in a therapy with a psychological or psychiatric care giver, or the like.

Thus, the present invention is directed also to a method for overcoming a fear, such as by improving self-confidence of a child, and includes the steps of:

a) providing a child with a container having a fluid dispenser and a fluid;

b) aiming the fluid dispenser at a locations selected by the child;

c) dispensing fluid in the selected direction;

d) repeating steps a-c until the child exhibits improved self-confidence.

Another aspect of the invention involves the employment of a storybook that includes a story with a plot or them designed to interactively engage the child and employs the above steps.

### BRIEF DESCRIPTION OF THE DRAWINGS

The features and inventive aspects of the present invention will become more apparent upon reading the following detailed description, claims and drawings, of which the following is a brief description:

FIG. 1 is a view of one illustrative dispensing apparatus of the present invention.

FIG. 2 is a view of another illustrative dispensing apparatus of the present invention.

FIG. 3 is a view of another illustrative dispensing apparatus of the present invention.

FIG. 4 is a view of another illustrative dispensing apparatus of the present invention.

FIG. 5 is a schematic of an illustrative kit of the present invention.

FIG. 5A is a schematic depiction of an assembly of a book and dispenser in accordance with one embodiment of the present invention.

FIGS. 6 and 7 are perspective views of an alternative illustrative embodiment of the present invention.

FIGS. 8 and 9 are perspective views of an alternative illustrative embodiment of the present invention.

FIGS. 10 and 11 are perspective views of an alternative illustrative embodiment of the present invention.

FIGS. 12 and 13 are perspective views of an alternative illustrative embodiment of the present invention.

FIGS. 14 and 15 are perspective views of an alternative illustrative embodiment of the present invention.

FIGS. 16A-16C are examples of illustrative excerpts from a storybook of the present invention.

### DETAILED DESCRIPTION OF THE INVENTION

The present invention pertains to an educational plaything for interactively engaging a person in the enactment of a story. In a particularly preferred embodiment, a situation is created in which a child's fear is elicited. For instance, the child may be told or read a story, listen to an audiotape, view a video, or the like, which leads the child to believe that a monster (or other like unpleasant imagining) is present in the child's bedroom.

The child is provided then with an instrument for assisting the child to confront the fear, and upon repetition of the confrontation, to improve self-confidence, and more preferably overcome the fear. The instrument generally will be configured to minimize the risk of bodily harm to the child, when used properly. An example of one suitable instrument is a dispensing device such as spray container (e.g., a plastic bottle, squirt gun, or the like) that contains a non-toxic fluid (preferably a liquid but possibly a gas, and optionally including a particulated material, bead or the like). In a preferred embodiment the fluid contains a fragrance. Other additives might be employed, such as one or more of a flavorant, a preservative, a cleaner, a detergent (e.g., for generating bubbles), a colorant or the like. The fluid could be scented, colored (e.g., with a water based colorant for ready cleanup). In another embodiment, the fluid might include a placebo ingredient (e.g., denoted as a “magic ingredient” or some other “special ingredient”) that is packaged or added to a container by a user separately from the above fluids.

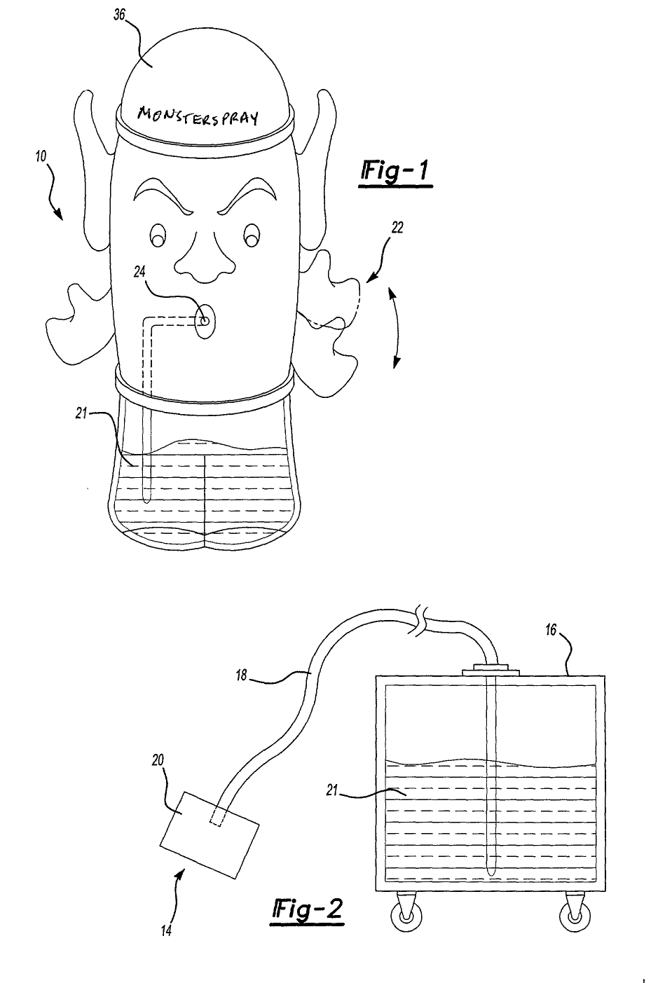

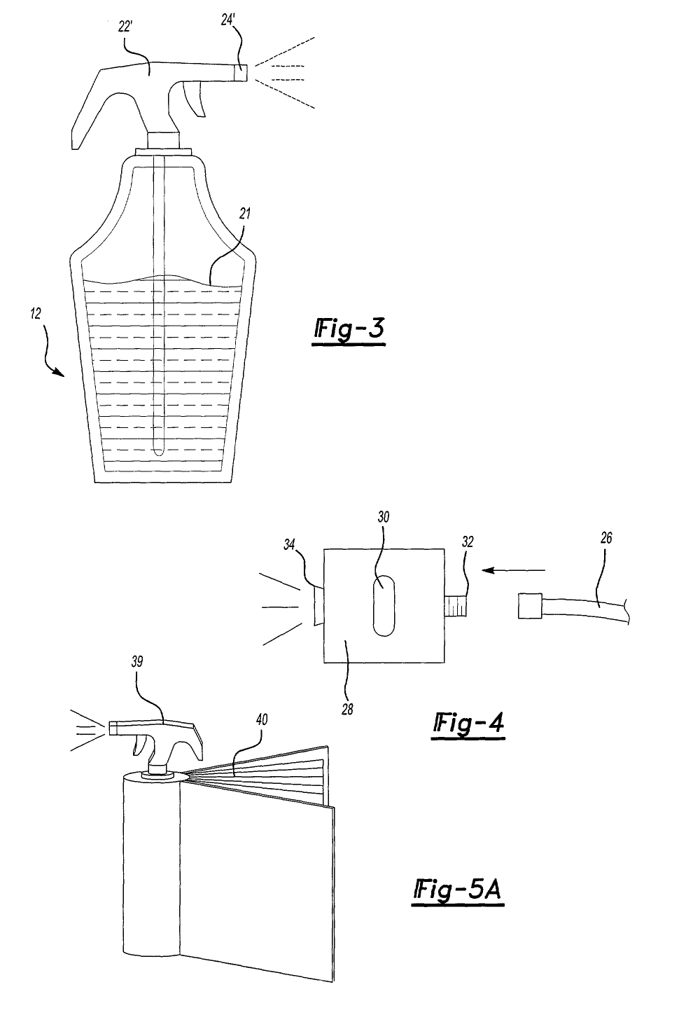

The dispensing device of the present invention preferably includes a molded plastic container. It may be clear or opaque, or it may contain one or more colors. Preferably the container is made of a thermoplastic material. More preferably, the plastic is a polyester, a nylon, a vinyl, a polycarbonate, a polyolefin or the like selected from the group consisting of polyethylene terephthalate, or polyethylene. Synthetic or natural rubber may also be used alone or in combination with the above materials. Some or all of the container or its associated components (e.g., a trigger, pump, nozzle or the like) may glow in the dark or fluoresce. In a preferred embodiment, it is blow molded, rotational molded, injection molded, thermoformed, compression molded, extruded, or otherwise formed to a predetermined configuration, and preferably a fanciful creature or article. For instance, as shown in FIG. 1, a container 10 might be molded in the shape of a fanciful creature, such as a person, animal, character, an object, or the like. It may be a generic configuration as well, as shown by the container 12 in FIG. 3. Whether molded to a predetermined configuration or not, suitable text or graphics may be incorporated on a surface of the container, e.g., by use of silk screening, adhesive labels, printing, paint, or the like. The outer surface of the container may also provide an erasable surface for allowing temporary customization, or for posting or writing messages, such as a chalkboard, dry-erase board, or the like. It will be appreciated that operation of the container may suitably require additional associated components, such as a pump, nozzle, trigger or the like. Preferably these components are suitably formed of a plastic material (e.g., polyethylene terephthalate, polyethylene, nylon, a vinyl, polycarbonate, polyester, rubber, or the like), such as by injection molding, or the like. Thus it is possible that the associated components of the container, the container or both may be configured as a fanciful creature, article or the like. As gleaned elsewhere herein, one example of a character or animal that can be formed is a monster (e.g., resembling a vertebrate, invertebrate, bird, reptile, mammal, gargoyle, demon, troll, ogre, goblin, fairy, ghoul, witch, warlock, clown, werewolf, dragon, dinosaur, or mixtures of two or more thereof). The fanciful creature may also be configured in the shape of a good person, such as a super-hero, an angel, a law enforcement official, a child, or the like.

FIG. 2 illustrates that another container 14 may be associated with a tank 16 (e.g., with or without wheels or other structure to facilitate portability), with a hose 18 and nozzle attachment 20 for dispensing its contents 21 (e.g., a fluid, particles or the like). Or as illustrated in FIGS. 1 and 3, it may be self-contained as a handheld device (e.g., a spray bottle with a trigger 22 (22′) and dispensing nozzle 24 (24′)). It may range in volume from an order of about one milliliter to several milliliters or more (e.g., about 0.25 liter, about 0.5 liter, about 1 liter or even larger). In one embodiment (see FIG. 4) in lieu of a tank or container, a fluid supply is provided as a line 26 that connects directly to a faucet, spigot, garden hose, separately supplied fluid canister or cartridge or the like. In this manner, the invention may be employed in connection with outdoor activities, shower or bath activities, cleaning activities or the like. For that embodiment, a housing 28 is adapted with a trigger or other dispensing actuator 30, a fitting 32 for attachment to a fluid supply and a nozzle 34. Other features optionally may be added as discussed above.

In another embodiment the container of the present device or its associated components has an additional component for generating a sensual effect (e.g., a light emitter, sound emitter, fragrance emitter, or otherwise) located on or proximate to the nozzle or other orifice through which fluid (or a particulated material, if used) exits the device. The light can be switched on and off in response to depression of a trigger so that the fluid is dispensed simultaneously with or sequentially with the light turned on or off. Thus, the light is on either before, during or after dispensing. The light may optionally include a strobe feature, or one or more filters or other attachments for affecting the beam. A plurality of lights might be employed as well. For instance, a sighting mechanism employing a light beam that turns on in advance of spraying can be employed alone, or in addition to the aforenoted light, allowing the user to take aim at a target location before spraying. Preferably any light employed will be battery operated and its associated circuitry will be electrically insulated from the fluid to be dispensed.

In another embodiment, a light is provided on the interior of the dispenser or container. A suitable light stick, (i.e., a flexible light emitting rod, cable or wire) might be attached to an inner or outer surface of the container or its associated components (such as a dispenser) as well.

In yet another embodiment, the container or its associated components is equipped with a sound emitter or other sound effect producer, such as a bell, a whistle, a siren, a beeper, an electronic sound reading device (e.g., activable by a separate card, chip or the like), a recorded verbal message or a combination thereof.

In another embodiment, the container also functions as a drinking cup or container, or includes a cap or other removable structure 36 that functions as a drinking cup or container. Thus it can be used at bedside for night-time drinking by a user. In this regard, the container may be fitted with a foam insulating sleeve, or other suitable thermal insulation for keeping fluids warm or cool as desired. Moreover, the container may be fitted with a suitable cap or top for allowing access to the interior of the container for filling or emptying fluid. For example a flip top or screw-type cap or top may be used.

In yet another embodiment, the container includes a suitable vaporizer, humidifier, or both for facilitating humidification proximate the user. In this manner, it may be employed for humidifying a room.

In yet another embodiment, the container has a suitably powered light and thus functions also as a flashlight or a nightlight.

The dispensing container device of the present invention (with or without its associated components) may be provided individually or as part of a kit. For instance, in one embodiment, a kit may include the container, and one or more items selected from an article of clothing (e.g., pajamas, t-shirt, hat, shoes, socks, diaper, underwear, training pants, costume or the like), plates, cups, silverware, foods (such as snack foods, breakfast foods, lunch foods, dinner foods, desserts, fast food meals, dairy products, meat products, bread or cereal products, or the like), nightlights, tissues, napkins, paper products, sticky notes, targets for aiming at, blankets, sheets, mobiles, music boxes, bags, backpacks, figurines (molded, stuffed or otherwise), books, coloring books, videotapes, dvd, compact disc, audiocassettes, watches, other toys, furniture, temporary or permanent tattoos, window treatments, floor coverings, towels, soap, shampoo or other health and beauty aids, medicine, vitamins or a combination thereof. The present dispenser may also be used as a co-promotional item to assist in the marketing of other products, such as a meal at a fast food restaurant, a concert, a toy or the like. Fluid refills might also be packaged together or separately, some possibly as a loadable cartridge.

Any of a number of accessories may also be used such as a strap for attachment to the dispensing device, a holster for holding the dispensing device, or the like.

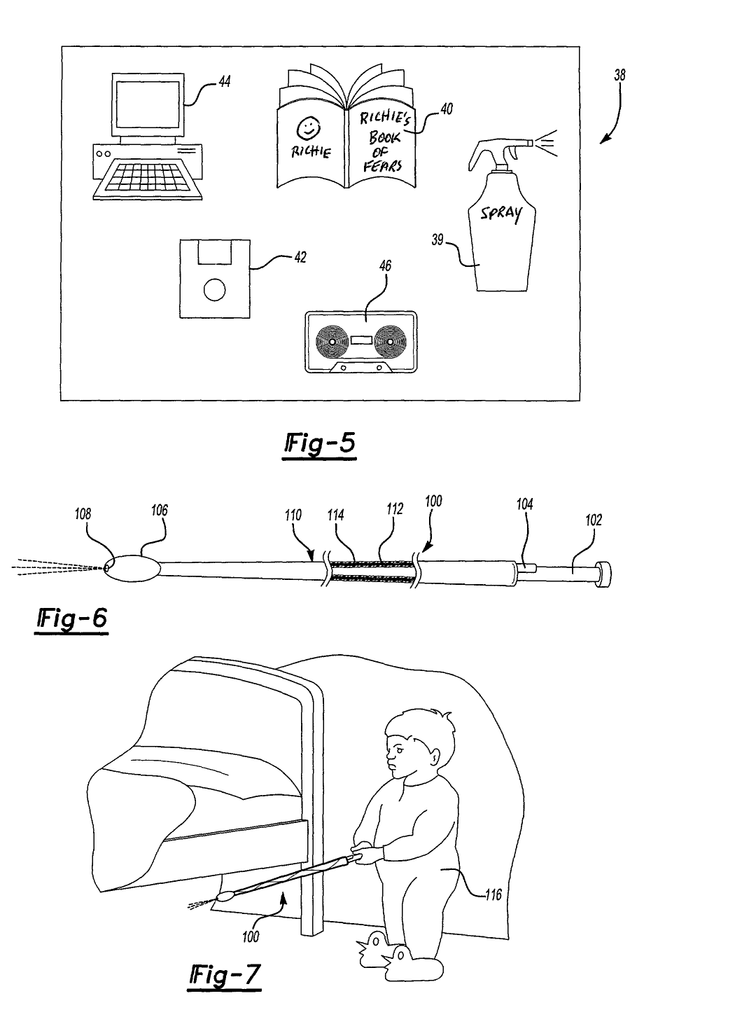

For example, the components of the present invention may be assembled, packaged, offered for sale, or otherwise provided as a kit 38. As seen in FIG. 5, the kit 38 might include one or more of a fluid dispenser 39, a story book 40, interactive software 42 (e.g. at a web site 44; for instance, a kit may include instructions for accessing a website), or both that tells a story of a young child who, rather than retreating away from a fear, confronts it. For example, the story book may include a theme about a child that confronts a fear of monsters by spraying a fluid at an imagined monster. The kit will generally be packaged so that a user is directed to follow along with the story, while operating the fluid dispenser and dispensing fluids, such as upon cues provided in the story, or at some other time. Such directions may be provided in any suitable form, e.g., in a book (e.g., as part of a story as described herein), an instruction sheet, or manual, a link to a website having instructions stored thereon, a cd or diskette with instructions thereon or the like.

Optionally a tape 46 (e.g., audio or video) is also provided with a recording to play out or otherwise help enact the story. The story will engage the reader to role play along with a character. In one preferred embodiment, the book or software includes a portion that is customizable for a particular user. For instance, provisions might be made (e.g., a frame, clear plastic sleeve, page, or the like) to include a picture of the user. Provisions might be made for the user to articulate the user's particular fear. It may optionally include provisions for a therapist to include reinforcement suggestions or other suggestions for overcoming the fear. The book or software could be adapted for permanent recording of the information by the user (e.g., for providing a keep sake), or for temporary recording (e.g., erasable). The book or software may also include renditions of the dispenser or container of the present invention.

A container is provided having therein a nontoxic fluid or powder, either with or without a pleasant fragrance. The container is equipped with associated components for dispensing the fluid, such as a trigger or pump sprayer for delivering a mist, a stream or both. Upon spraying, the child is given the impression that the fluid has either destroyed a monster or other fear, repelled it or otherwise has protected the child from an encounter with the monster or other fear.

As indicated, in another embodiment of the present invention, shown schematically in FIG. 5A, the dispenser 39 or its associated components are configured for permanent attachment or temporary mechanical attachment to a tangible story medium, such as a book 40 (e.g., having at least about 8 pages, and more preferably about 12 to about 36 pages, and still more preferably about 18 to about 28 pages (e.g., about 22 to about 24 pages). In one embodiment, a book is adapted to include a holder for the container or its associated components. In yet another embodiment, the container or its associated components are adapted for temporarily receiving a book, or the book is adapted for temporarily receiving the container or its associated components. For example, a groove is formed on the exterior of the container or its associated components into which the spine of the book can be slid. A fastener, hook, hook and loop fastener, snap, strap, pressure sensitive adhesive or the like may also be included as desired to removably assemble the book relative to the container or its associated components. Temporary attachment may also be accomplished by providing a common carrying structure (e.g., a molded plastic holder, tray, bag, box or other container) for both the container or its associated components and the tangible story medium. This may also be done for instance by embedding an audio output device in the container or its associated components.

Additional embodiments are also gleaned from a review of FIGS. 6-16c. In general, the present invention contemplates the spray of a stream or mist of a fluid at a fear evoking target. However, as mentioned, it is also possible to use alone or in combination with the fluid targeting with an optical device, a sound device, or the like. For example, one embodiment may feature a lighted wand or other device from which sound or a fluid may optionally be omitted. Additionally, it is contemplated that the device for aiming at a fear evoking target may be remotely operated, e.g., by radio frequency, a cable, a tether or the like. In general, the device will be portable and handheld, but it may also be a free-standing device, such as a floor-standing device or an upright device on roller for transportability of the device itself or the device in combination with a passenger user.

Turning more particularly to FIGS. 6 and 7 there is shown one example of a type of device 100 having fluid dispensing and an optional light emitting function. This type of device 100 preferably has a handle 102, an actuating trigger 104, and a light emitter 106. A suitable nozzle 108 is provided for emitting fluids from the device. A fluid tank portion 110 is also included.

In one specific embodiment, as is shown in FIG. 6, the tank portion may include opposing spaced walls 112 and 114 (clear, opaque or a combination thereof). A fluid or other material to be dispensed may be filled in the space between the walls, within the space-defined by the interior of the inner wall 12 or both. It may also be filled in a bladder associated with an assembly including the light emitter 106, the handle 102, or both.

Preferably the actuating trigger 104 is dual functional and will control fluid dispensing and light emission. Single function triggers (one or a plurality) may also be employed.

Preferably the device is battery operated and the battery holder may be located, for example in the handle 102.

The light emitter 106 may be adapted to light up at predetermined intervals, in response to a trigger signal, or it may remain lit at all times that the device is operating. It may include a light bulb, an LED, a fiber optic, a phosphor or the like for emitting light, optionally enclosed in a suitable transparent housing, opaque housing or combination thereof.

Preferably the components are made primarily of molded plastic (e.g., blow molded, injection molded, compression molded or the like). Secondary assemblies, such as the electrical components can be insert molded in place or separately attached. Though shown as an elongated wand, the device 100 may take any suitable shape and may have color or decorative detail printed (e.g., pad printed), molded or otherwise applied.

FIG. 7 illustrates the device 100 in operation by a user 116. The user may be instructed to aim the device 100 at the fear evoking subject matter and emit the light, dispense fluid or both in the direction aimed, e.g., under a bed, under a table, behind or into drawers or cabinets, into closet, into an attic or the like.

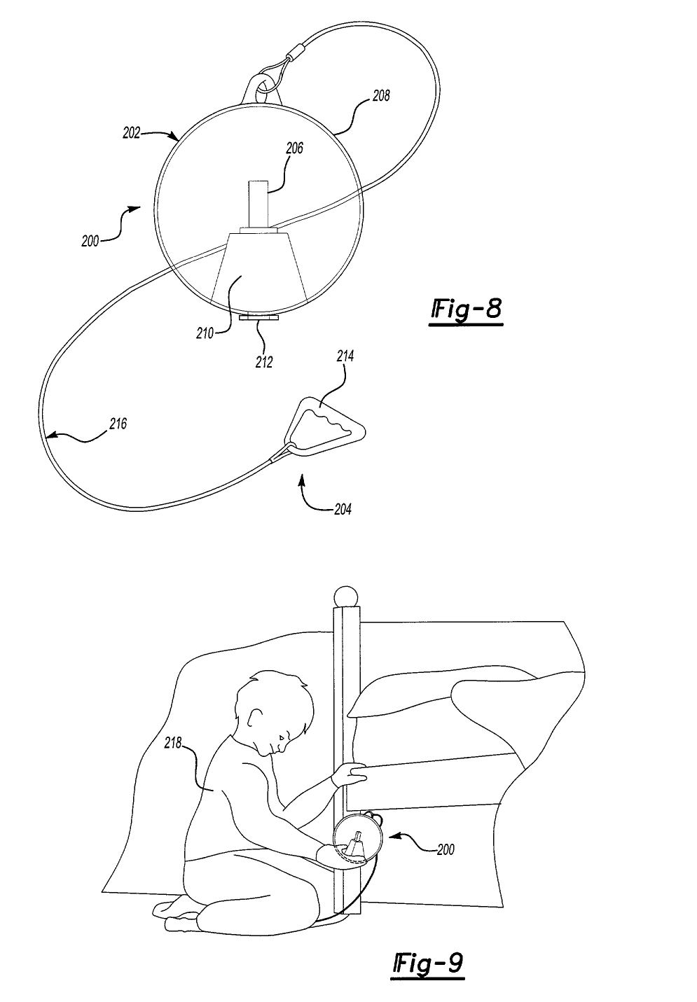

FIGS. 8 and 9 illustrate an example of a remote type device 200. The remote device 200 includes an active portion 202 and a recovery portion 204. The active portion 202 includes one or more of a light 206 (e.g., for continuous light emission, time-triggered emission or intermittent emission, such as a strobe light), a sound emitter, or a dispenser. The light 206 is enclosed in a housing 208, which also preferably encloses any electrical or mechanical functional components (e.g., light emitter, speaker, batteries, capacitor charging or discharging system, timer, nozzle, tank for fluid, or the like), such as in a cabinet 210. A switch 212 preferably is mounted to the exterior of the housing 208. It may also be located inside the housing; for instance, being accessible via a door.

The recovery portion 204 preferably includes a gripper 214 that is connected to the housing by a tether 216. Optionally, the tether also functions as a signal transmission.

FIG. 9 shows that a user 218 may be directed to switch on the device, place or direct the active portion 202 toward the region of the fear evoking matter and then retrieve the active portion 202 using the gripper.

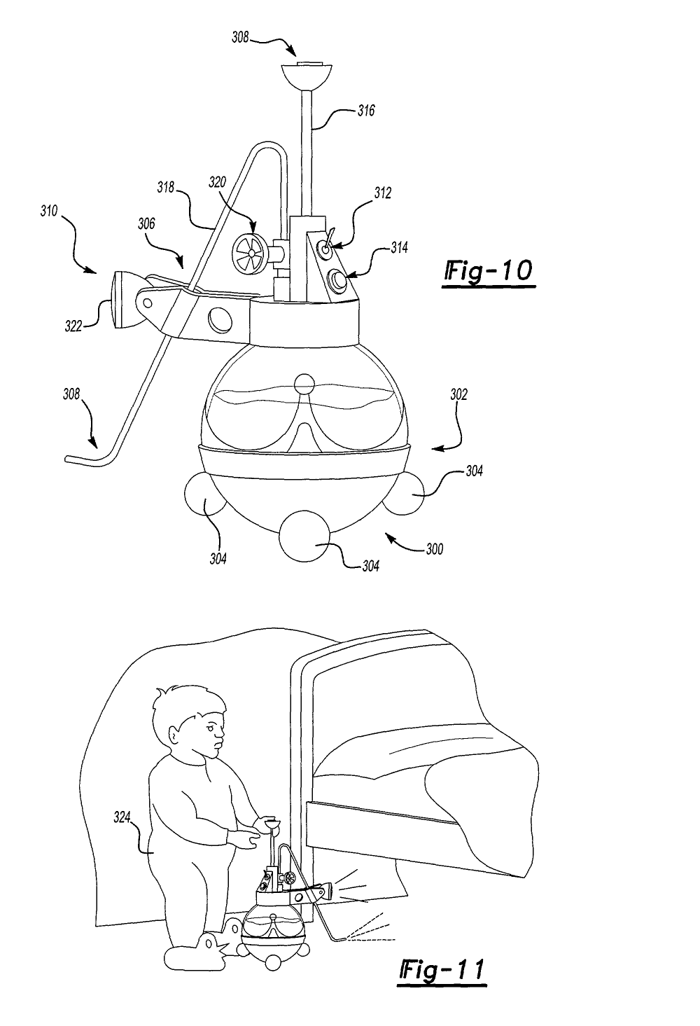

FIG. 10 illustrates a floor standing device 300 having a base portion 302 (which may include a fluid tank) with feet 304 or optional rollers associated therewith. The device 300 has a functional component housing (e.g., for components such as discussed for the embodiment of FIGS. 8 and 9) portion 306, an actuating portion (which may be spaced from the housing portion 306), and one or more of a fluid spaced from the housing portion 306), and one or more of a fluid dispensing portion 308 a light emitting portion 310 or a sound emitting portion (not shown).

Various functional or decorative features may be incorporated as desired. For example, a light switch 312, a sound emission switch 314 may be placed outside of the housing 306. The fluid dispensing portion 308 might include a plunger 316 that dispenses through an elongated tube 318, with an optional functional or decorative valve 320. A light 322 may be pivotally attached to the assembly or fixed in single position.

As seen in FIG. 11, a user 324 may be directed to transport the device to its desired location and to depress the fluid dispenser upon taking aim of the intended target.

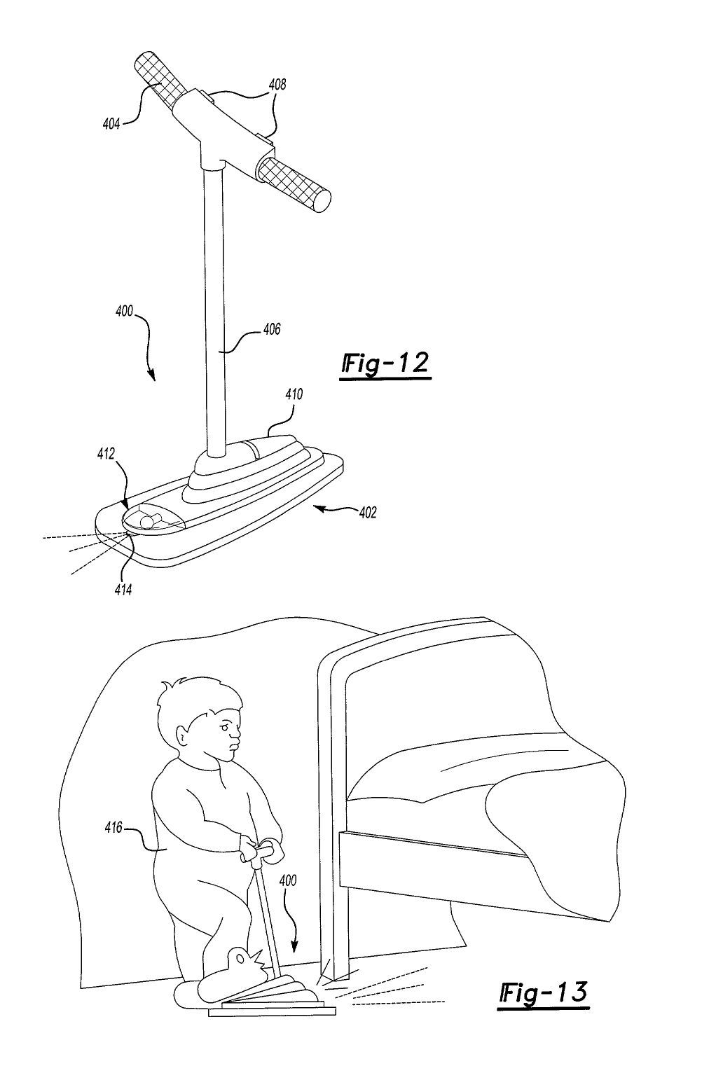

FIGS. 12 and 13 illustrate another floor standing device 400. In this embodiment, a base portion 402 serves as a housing for the functional components and a fluid tank. Optional handle bars 404 are spaced from the housing with a post 406. One or more switches 408 may be assembled onto the handle bars 404. The device 400 may also be adapted for foot operation (e.g., by providing a suitable bellows pump 410 or optional electronic pump switch). The base portion 402. Also preferably includes any light emitter 412 or nozzle 414.

A user 416, as shown in FIG. 13 may be directed to take aim at a desired target and depress the bellows pump or like fluid dispensing actuator.

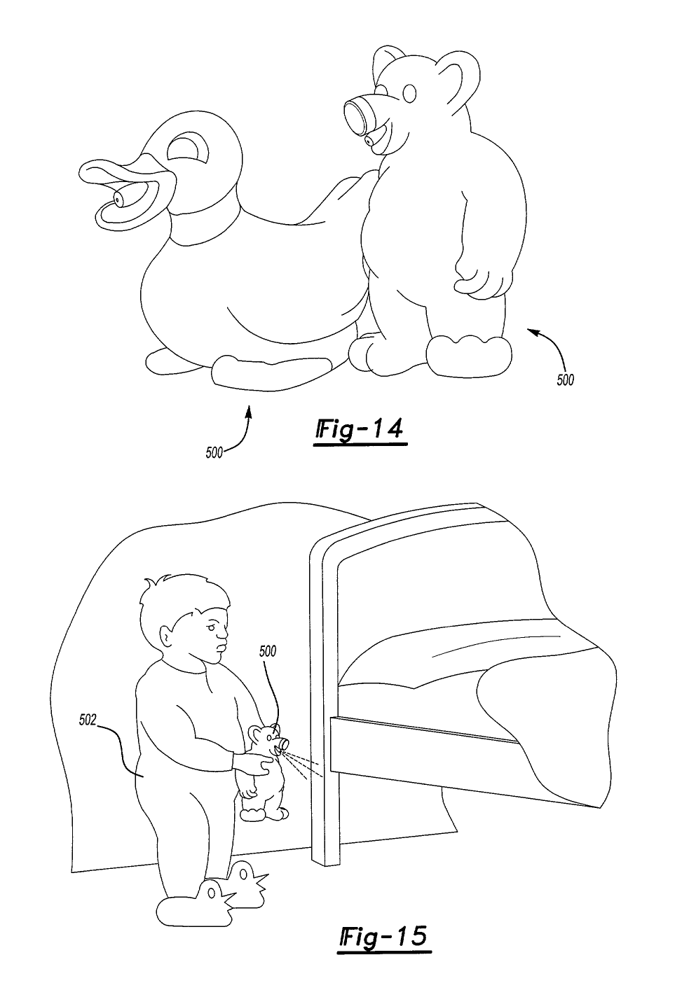

FIGS. 14 and 15 illustrate additional examples of dispensers 500 of the type illustrated in FIG. 1, in which a user 502 is directed to squeeze a molded figure (akin to bath tube squeeze toys or pet squeaky toys) that include or itself defines a bladder, for causing fluid in the bladder to be expelled.

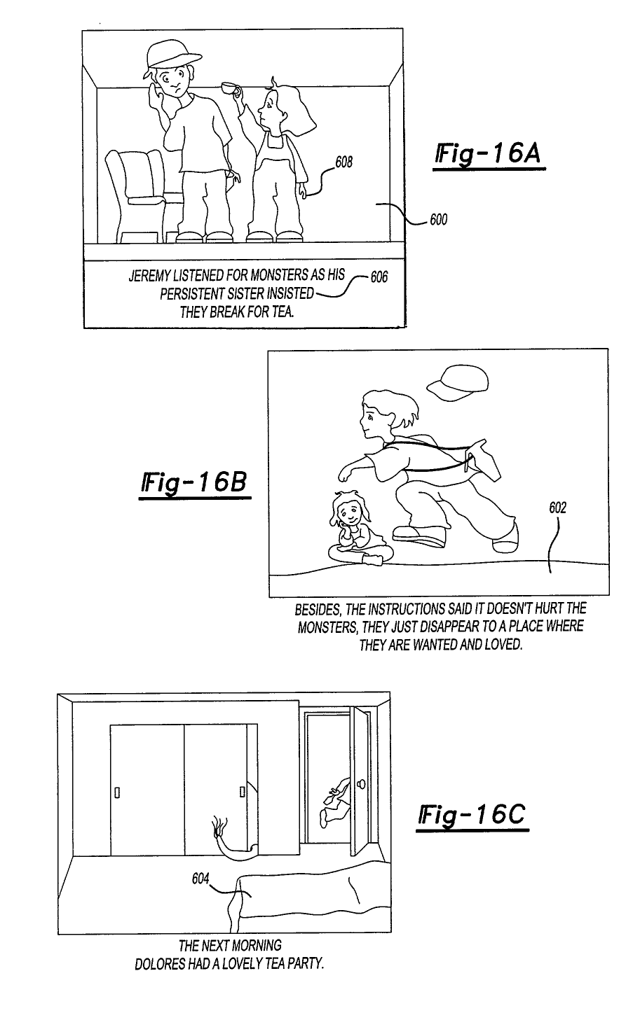

FIGS. 16A-16C illustrate sample pages 600, 602 and 604 from a storybook, in which the use of a device in accordance with the present invention is aided by the telling of a story having one or both of text 606 or illustrations 608 on the same or adjacent pages.

A preferred method will include including in the story a theme that evokes a fear of the user and allows the user to confront the fear, for example, by observing how characters in the book confront the fear; by defining a role-playing situation in which the user is gently coaxed to positively respond to the fear; by repetition of the fear evoking situation without incident; or a combination thereof.

By way of example, the story will preferably introduce an antagonist character (which is intended to embody the object of a child's fear). The protagonist of the story may be a child like the user, or may be a depiction of the child user himself or herself. Early in the story the user, along with the protagonist, will be invited to use a spray device, as described herein, and be provided with instructions for the proper handling of the device. Through adventures of the protagonist, the story will encourage the user to seek out different environments in which the fear is likely to be invoked (e.g., dark places, secluded places, etc.), while at the time being in possession of the spray device. The story may include one or more encounters, in which the protagonist is subjected to false alarms, potentially causing the user to prematurely use the spray device. In one embodiment, if false alarms are provided, preferably enough of them are provided so that after one or more of them the user will be induced to deliberate before acting upon the fearful situation. The story will also instruct the user properly directing the spray device at the true object of the user's fear and not transferring it to third persons or objects (e.g., other family members, pets, or the like). The story preferably will climax with the protagonist confronting the fear and eradicating it. Overall, the preferred story will be non-violent and generally not distressing, with a light and fun tone.

It is also possible that the invention can dispense powder materials, beads or the like at a target. Thus, the invention is not intended as being limited to fluid dispensing. The components of each illustrative embodiment may be combined with components of other embodiments and still be within the present invention. The suggestion of a preferred manufacturing method does not foreclose the use of alternative methods. The example, any of a number of different plastic processing techniques may be used such as injection molding, blow molding, compression molding, rotational molding, thermoforming, extrusion or otherwise.

Preferably, one or more of the materials used herein are recycleable. Thus, another preferred embodiment contemplates directing a user to recycle the materials upon the conclusion of its useful life.

In one embodiment the practice of the present invention leads to the ability of a user (e.g., a child) to immediately overcome a fear or improve self-confidence. In another embodiment, the practice of the present invention is employed repetitiously (e.g., one or more times, nightly, weekly or monthly).

### EXAMPLE 1

A situation is created in which a child (e.g., ages about 2 and up, more preferably ages about 3 to 9) believes that a monster (or other like unpleasant imagining, e.g., goblin, fairy, ghoul, witch, warlock, or the like) is present in the child's bedroom. A container (e.g., a bright or colorful molded plastic container) is provided and labeled under a designation such as “MONSTERSPRAY”. The container has therein a nontoxic fluid with a pleasant fragrance. The container is equipped with a pump for dispensing the fluid, such as a sprayer, and is sized for ease of manual use by the child (e.g., having a squeeze trigger sized for a child's hand). Upon spraying, the child is given the impression that the fluid has either destroyed a monster, repelled it or otherwise has protected the child from an encounter with the monster. A child who uses this regularly should start to exhibit reduced night time fears and greater self confidence and independence.

### EXAMPLE 2

An Example of one possible story that is employed in the present invention is set forth in the following, with the spray device of the present invention being referred to as a “monster mister”:

SHNEEEEE!!!!!

Walter woke up to a sneeze that came from under his bed. . . . a scary sort of sneeze that only a monster could make. Of this he was certain. And it was surely the monster that had followed him for days. So, it was time to try out his new monster mister.

- - -

He read the label once again.

“Works on genuine monsters only. Harmless to people or pets.

Directions:

1. Point toward monster.

2. Spray just once.

3. Count to three—and the monster will disappear to a place where it can be loved.”

- - -

Brave Walter pointed under the bed, squeezed the handle, and counted . . . “one, two, three” . . .

- - -

. . . out crawled a very wet and angry cat. This was not a good start to a monster hunt.

- - -

His persistent sister insisted they have a tea party. But Walter had more important things to do. He began the hunt in the wild backyard.

- - -

Right away he saw it. “Flippitty flap!” . . . it's wings fluttered as it sat in the lounge chair, with furry feet and stripey tail dangling. He watched it's knobby head nodding in shadow . . . a scary, hairy shadow that only a monster could make. Of this he was certain.

- - -

Brave Walter crept up behind, pointed over the chair, squeezed the handle, and counted “one, two, three . . .

- - -

. . . out popped the head of his very wet and angry mother!

(in the drawing we see her “knobby head” is curlers, her “stripey tail” is her bathrobe tie, and her “wings” are her newspaper)

- - -

This was not a good thing at all. But Walter had to continue the hunt . . .

- - -

Walter was brushing his teeth and making new plans, when he heard it . . . skreeek SKREEEEL GWAAAAAHR” . . . a terrible squeaking and groaning came from behind the shower curtain . . . a scary, squeely noise that only a monster could make! Of this he was certain.

- - -

Brave Walter pointed around the curtain, squeezed the handle, and counted . . . “one, two, three” . . .

- - -

. . . out stepped his very wet and angry father!

(the dad is holding a plumbing wrench.)

- - -

This little mishap nearly put a stop to the hunt. But Walter still had to search in the scariest place of all . . .

- - -

. . . the basement! Yes, it was dark. Yes, it was cold. And it was also very big. Walter was wondering where to begin, when he felt it . . . “schnorfal, schnifft, phnah” . . . a snorty, spitty, wet breathing on the back of his neck . . . the scary, snorty sort of breathing that only a monster could make. Of this he was certain.

- - -

Brave Walter pointed over his shoulder, squeezed the handle, and counted . . . “one, two, three” . . .

- - -

. . . and behind him stood his very wet and angry sister! with a face uglier than any monster. And out came the most horrible scream! Scarier than any sound a monster could make!

Walter ended the hunt temporarily.

- - -

At bedtime Walter did a lot of thinking. Instead of getting rid of a monster that day . . . he had MADE some monsters. He had turned his family into very wet and angry creatures. So, it was time for a new strategy . . . which would include NOT aiming at pets and relatives. He lay quietly planning, when he heard it . . .

- - -

BLAAAAAAAAAAAAAARP!!!!! . . . a deep, rumbling burp came from inside his closet . . . a scary, smelly burp that only a monster could make. Of this he was certain . . . maybe.

- - -

With one more try, brave Walter pointed into the closet, squeezed the handle, and counted “one, two, three” . . .

(Walter can't see it, but we can barely see a monster in the closet)

- - -

and nothing. When he threw back the door there was nothing! Had there been something? Of this he was not certain.

- - -

But at least this time he had not angered any pets or relatives . . . and that made Walter feel worthy of a good sleep . . . as it should. And maybe . . . just maybe the monster mister had worked, and he had gotten rid of the monster that had followed him for days . . . and sent it to a place where it could be loved.

- - -

(On the last page Walter's sister is shown in her closet, having tea with the monster)

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1) A method for assisting a child to overcome a fear with a plaything, comprising the steps of:
a) providing a fluid dispensing component selected from a nozzle, a molded plastic container or a combination thereof;
b) fixing in a tangible medium a story written for helping a child to confront and overcome a fear;
c) causing access to the story to be packaged in combination with the fluid dispensing component;
d) directing an end user to read the story and to dispense a fluid using the fluid dispensing component at select intervals during such reading.

2) The method as in claim 1, wherein the fluid is prepared by the end user.

3) The method as in claim 2, further comprising providing at least one ingredient for the fluid as a powder characterized as a special ingredient.

4) The method as in claim 2, further comprising providing at least one ingredient for the fluid as a liquid characterized as a special ingredient.

5) The method as in claim 1, wherein the molded container is configured as a fanciful creature.

6) The method as in claim 1, wherein the nozzle is configured as a fanciful creature.

7) The method as in claim 1, wherein the container is separate from the dispenser and is connected by a tube.

8) A method for assisting a child to overcome a fear with a plaything, comprising the steps of:
a) providing a fluid dispensing assembly including a nozzle, and a molded container made of a plastic selected from the group consisting of polyethylene terephthalate, or polyethylene;
b) causing the blow-molded container to be filled with a generally inert and non-toxic, water-based fluid;
c) providing a book including a theme about a child that confronts a fear by spraying a fluid at an imagined situation;
d) causing the book to be packaged in combination with the fluid dispensing assembly;
e) directing an end user to read the book and to dispense fluid from the blow-molded container at select intervals during such reading that are identified by in the book.

9) The method as in claim 8, further comprising providing an audio rendering of the story of the book.

10) The method as in claim 8, further comprising providing a video rendering of the story of the book.

11) The method as in claim 8, further comprising providing a battery operated device that is adapted for attachment to the nozzle, the container or both.

12) The method as in claim 11, wherein the battery operated device includes a light emitter.

13) The method as in claim 11, wherein the battery operated device includes a sound emitter.

14) A method for assisting a child to overcome a fear of monsters with a plaything, comprising the steps of:
a) providing a fluid dispensing assembly including a nozzle, and a blow-molded container made of a plastic selected from the group consisting of polyethylene terephthalate, or polyethylene, at least one of the nozzle or the container being molded in the configuration of a fanciful creature;
b) causing the blow-molded container to be filled with a generally inert and non-toxic, water-based fluid;
c) providing a book including a theme about a child that confronts a fear of monsters by spraying a fluid at an imagined monster, the book and the container being adapted for temporary mechanical attachment to each other;
d) causing the book to be packaged in combination with the fluid dispensing assembly;
e) directing an end user to read the book and to dispense fluid from the blow-molded container at select intervals during such reading that are identified by in the book.

15) The method as in claim 14, further comprising providing an audio rendering of the story of the book.

16) The method as in claim 14, further comprising providing a video rendering of the story of the book.

17) The method as in claim 14, further comprising providing a battery operated device that is adapted for attachment to the nozzle, the container or both.

18) The method as in claim 17, wherein the battery operated device includes a light emitter.

19) The method as in claim 17, wherein the battery operated device includes a sound emitter.

20) The method as in claim 14, further comprising providing at least one additional rendering of the story of the book selected from an audio rendering, a video rendering or a combination thereof.
